(19) United States
(12) Patent Application Publication
(10) Pub. No.: US 2004/0071900 A1
(43) Pub. Date: Apr. 15, 2004

(54) Binding substrate for inkjet inks

(76) Inventors: Gustav Allen Ray, Pacifica, CA (US); Ravi Shankar Renduchintala, Mountain View, CA (US)

Correspondence Address: Gustav Allen Ray, 48 Desvio Court, Pacifica, CA, 94044, US

(21) Appl. No.: 10/267,120

(22) Filed: Oct. 10, 2002

(51) Int. Cl. B32B 3/00

(52) U.S. Cl. 428/32.1

(57) ABSTRACT

A binding substrate comprising a substrate bearing on at least one major surface thereof a water receptive layer which comprises at least one polymer and an effective amount of an ink binding polymer that has an amino as well as a guanidine functional moiety incoporated in it. One such molecule that essentially has both the amino and guanidine moieties is polyaminopropyl biguanidine. The present invention describes the use of polyaminopropy biguandine in inkjet technology.

### CROSS REFERENCE TO RELATED APPLICATIONS

Not applicable

### STATEMENT REGARDING FEDERALLY SPONSORED RESEARCH OR DEVELOPMENT

Not applicable

### REFERENCE TO MICROFICHE APPENDIX

Not applicable

### BACKGROUND OF THE INVENTION

Binding substrates are an established means of irreversably or reversably binding inks.

In the case of inks, imaging devices such as ink jet printers and pen plotters are established methods for printing various information including photos and multicolor graphics. Presentation of such information has created a demand for ink-receptive binding substrates useful for commercial and non-commercial graphics. Imaging with the ink jet printer involves depositing ink on the surface of these binding substrates.

It is desirable that the surface of these binding substrates be dry and non-tacky to the touch, even after absorption of significant amounts of liquid soon after binding the inks. Transparent polymers containing polyaminopropyl biguandine that are capable of absorbing significant amounts of liquid while maintaining some degree of durability and transparency, are useful as a binding substrate.

Liquid-absorbent materials are well known. These materials comprise crosslinked polymeric compositions capable of forming continuous matrices for liquid absorbent semi-interpenetrating polymer networks. These networks are blends of polymers such as polyvinyl alcohol 325 available from Celanese Chemicals and Polyvinyl Pyrolidon PVP K90 available from ISP Corporation, Further, at least one of the polymeric components may be crosslinked after blending to form a continuous network throughout the bulk of the material, and through which the uncrosslinked polymeric components are intertwined in such a way as to form a macroscopically homogenous composition. Such compositions are useful for forming durable, water absorbent, transparent binding substrates.

The present inventors have now discovered a cost effective ink receptive material, which when used as binding substrate yields improved shelf life after binding, resistance to water, and strong binding of the inks to the substrate. Even after the imaged polymeric coating is exposed to elevated temperature, high humidity and running water.

Polymeric mordants are well known in the photographic sciences and normally comprise materials containing quaternary ammonium groups, or less frequently phosphonium groups.

U.S. Pat. No. 2,945,006 comprises mordants which are reaction products of aminoguanidine and carbonyl groups.

U.S. Pat. No. 4,695,531 discloses mordants in a light-sensitize silver halide element for radiographic use. A spectrally sensitized silver halide emulsion layer is coated on at least one side of a transparent case, and coated between the case and the silver halide emulsion layer is a hydrophilic colloid layer containing a water-soluble acid dye capable of being decolorized during the photographic process. This dye is associated with a basic polymeric mordant

### BREIF SUMMARY OF THE INVENTION

The invention provides an improved ink-receptive layer, and ink-receptive substrates having an improved ink-receptive layer, which exhibits longer imaged shelf life, even when exposed to elevated temperatures, humidity and running water. The substrates of the invention show a marked reduction or elimination of ink “bleeding” and thus remain useful over a long period of time.

The improved ink-receptive substrates of the invention comprise a substrate bearing on at least one major surface thereof, an ink-receptive layer comprising an ink receptive polymer and an effective amount of at least one mordant comprising a polyaminopropylbiguanidine.

### BRIEF DESCRIPTION OF THE SEVERAL VIEWS OF THE DRAWING

Not applicable

### DETAILED DESCRIPTION OF THE INVENTION

Mordants useful in ink-receptive substrates of the invention contain polyaminopropylbiguanidine.

The ink-receptive layer of the improved ink-receptive substrate of the invention further comprises a polymeric ink-receptive material. Although at least one of the polymers present in the polymeric ink-receptive material is preferably crosslinkable, the system need not be crosslinked to exhibit the improved longevity and reduced bleeding. Such crosslinked systems have advantages for dry time.

Preferably the ink-receptive layer comprises a polymeric blend containing at least one water-absorbing, hydrophilic, polymeric material, and at least one hydrophobic polymeric material incorporating acid functional groups.

The water-absorbing hydrophilic polymeric material comprises homopolymers or copolymers of monomeric units selected from vinyl lactams, alkyl tertiary amino alkyl acrylates or methacrylates, alkyl quaternary amino alkyl acrylates or methacrytates, 2-vinylpyridine, hydroxy ethyl methylmethacrylates and 4-vinylpyridine. Polymerization of these monomers can be conducted by free-radical techniques with conditions such as time, temperature, proportions of monomeric units, and the like, adjusted to obtain the desired properties of the final polymer.

When desired, a polyethylene glycol can be added to the ink-receptive layer for the purpose of curl reduction. Lower molecular weight polyethylene glycols are more effective for reducing curl while maintaining a low level of haze. Accordingly, it is preferred that the polyethylene glycol have a molecular weight of less than 4000 and most preferably of 600.

In a preferred embodiment, the ink-receptive coating is an

(1) polyvinyl alcohol;

(2) Polyvinyl pyrolidon

(3) Polyaminopropy Biguandine

The amount of crosslinking agent to be used is preferably that amount that will react with 5 to 150 mole percent, preferably 25 to 90 percent, of the unreacted anhydride units of the polymer that forms the matrix. When the crosslinking agent is added in an amount capable of reacting with more than 100 mole percent of the unreacted maleic anhydride units, unreacted hydroxyalkyl moieties will remain as part of the crosslinked product.

While it is the primary function of the crosslinkable component to impart physical integrity and durability to the coating without adversely affecting the overall liquid absorbency of the coating, it is the primary function of the liquid-absorbent component to promote absorption of liquids. When aqueous liquids are to be absorbed, as is in the case of most inks, the liquid-absorbent component must be capable of absorbing water, and preferably be water-soluble. Further a multi layer system may be used in which the top liquid absorbent layer containing the polyaminopropy biguandine is crosslinkable to a second layer consisting of a crosslinker and a polymeric component. Further said crosslinkable second layer may also serve as a means of attaching the layers to a substrate. Non limiting examples of said substrate are paper, polyethyelene coated paper, polyester and vinyl.

The ink-receptive layer can also include particulate material for the purpose of improving handling and flexibility. Preferred particulate materials include polymeric beads, e.g., poly(methylmethacrylate), poly(stearyl methacrylate)hexanedioldiacrylate copolymers, poly(tetrafluoroethylene), polyethylene; starch and silica.

The ink-receptive layer can be applied to the film backing by any conventional coating technique, e.g., deposition from a solution or dispersion of the resins in a solvent or aqueous medium, or blend thereof, by means of such processes as Meyer bar coating, knife coating, reverse roll coating, rotogravure coating, slot die and the like.

Drying of the ink-receptive layer can be effected by conventional drying techniques, e.g., by heating in a hot air oven at a temperature appropriate for the ink-receptive layer and the specific film backing chosen, infared, UV curing, microwave and the like.

The suitable substrate may be transparent, opaque, or translucent. The substrate may be paper based or film based or any other material such as glass or metal. Preferably, the substrate is photobased coated paper. More preferably, the substrate is photobased paper having a coating for waterproofability, such as polyethyelene.

Optionally, the polyethylene coating has a coating thereon to improve coatability of the polyethylene layer with the ink absorbent layer. One such coating is gelatin which is commercially available. Alternatively, other means, such as corona discharge treatment, may be used to provide the improved coatability of the polyethylene layer. To promote adhesion of the ink-receptive layer to the film backing, it may be desirable to treat the surface of the film backing with one or more primers, in single or multiple layers. Useful primers include those known to have a swelling effect on the film backing polymer. Examples include halogenated phenols dissolved in organic solvents. Alternatively, the surface of the film backing may be modified by treatment such as corona treatment or plasma treatment.

Further, The polymeric nature of polyaminopropy biguandine causes ionically binding with the acid groups of the other polymers that may be used in the formulation thereby increasing the cross linking of the polymeric system which eventually gives wet rub resistant inkjet prints.

Further, the polymeric nature of the polyaminopropy biguandine acts as a plasticizer in certain polymeric inkjet coating formulations. A non limiting example is polyaminopropy biguandine's ability to increase the flexibility of hydroxyethylmethylmethacrylate (HEMA) polymers.

The primer layer, when used, should be relatively thin, preferably less than 2 micrometers, most preferably less than 1 micrometer, and may be coated by conventional coating methods. The polyethylene layer, in addition to improving waterproofing of the medium, also provides for the desired porosity, absorption, dry time, and smoothness

The following examples are for illustrative purposes, and do not limit the scope of the invention, which is that defined by the claims.

Test Methods

Test samples were coated at 20 grams per square meter solids. The samples were then printed on with a HP 960 printer containing a print pattern with solid bars of cyan, magenta, yellow and black. One hour after printing 3 ml of water were dropped on the solid printed bars and examined for color bleed.

What is claimed is:

1. An ink binding substrate comprising a substrate bearing on at least one major surface thereof, a hydrophilic layer comprising a hydrophilic polymer and an effective amount of polyaminopropylbiguanidine.

2. An ink-receptive substrate according to claim 1 wherein said ink-receptive layer comprises from about 1 part by weight to about 20 parts by weight of polyaminopropylbiguanidine.

3. An ink-receptive substrate according to claim 1 wherein said substrate is a polyethylene coated cellulose substrate.

4. An ink-receptive substrate comprising a substrate bearing on at least one major surface thereof an ink-receptive layer comprising:
a) a polyaminopropyl biguandine mordant;
b) at least one polymeric liquid-absorbent component,
c) and a polyfunctional aziridine crosslinking agent.

5. A method for binding inks to a polymeric inkjet coating using polyaminopropy biguandine.
